(19) United States
(12) Patent Application Publication
(10) Pub. No.: US 2026/0131953 A1
(43) Pub. Date: May 14, 2026

(54) ZERO-EXPOSURE FORMALIN PREFILLED CONTAINER

(71) Applicant: Richard-Allan Scientific, LLC, Kalamazoo, MI (US)

(72) Inventors: Kevin John VerHulst, Shelbyville, MI (US); Robert Kevin Brown, II, Portage, MI (US); Blai Saleta, Jackson, NH (US); Paige Elizabeth Galvin, Portsmouth, NH (US)

(21) Appl. No.: 18/943,431

(22) Filed: Nov. 11, 2024

(51) Int. Cl. B65D 51/28; A61J 1/14; B65D 43/02; B65D 43/16; B65D 55/16; B65D 81/22

(52) U.S. Cl. CPC B65D 51/2835; A61J 1/1406; B65D 43/0231; B65D 43/162; B65D 55/16; B65D 81/22; B65D 2251/09; B65D 2543/00092; B65D 2543/0025; B65D 2543/00537

(57) ABSTRACT

A container system for housing a specimen and a substance. The container system may include a container body receiving the specimen and a container lid selectively fastenable to the container body, the container lid and the container body forming a sealed enclosure when fastened together. The container system may include a compartment extending from an underside of the container lid, the compartment retaining the substance when the compartment is sealed. The container system may include a compartment film attached to the compartment, the compartment film sealing the substance in the compartment. The container system may include a piercing tool protruding upward from an interior wall of the container body, the piercing tool piercing the compartment film and releasing the substance when a predetermined pressure is applied to the compartment film by the piercing tool.

### BACKGROUND

### 1. Field

Embodiments of the present disclosure relate to containers. More specifically, embodiments of the present disclosure relate to medical containers for receipt of a tissue sample and providing for minimal to zero exposure to harmful particulates and vapors, including from formalin.

### 2. Related Art

Body tissue samples are commonly used for medical research, including histology and pathology. The setting in which a tissue sample is gathered is often different than the setting in which the tissue sample is studied. For example, a tissue sample can be removed from the patient in various medical environments, including surgery rooms, outpatient wards, or doctors' offices. Conversely, tissue samples are often processed and studied in environments such as laboratories. After their removal from the body, tissue samples are placed in a labeled container for transport. Typically, the container contains a fixative, such as formalin. The fixative preserves the sample during transportation so that the sample may be studied at the laboratory.

Exposure to the formaldehyde in formalin can irritate the skin, throat, lungs, and eyes, often leading to chronic conditions (such as asthma) with repeated exposure. Under conditions of unusually high or prolonged exposures, formaldehyde is classified as a carcinogen. Despite the dangers of formaldehyde, environments where the containers with formalin are used (e.g., a laboratory) seldom feature the required air extraction to prevent exposure to the formalin, leaving many healthcare workers without adequate protection. U.S. patent application Ser. No. 18/520,099 to Liposits, et al. (herein incorporated by reference in its entirety) discloses a zero-exposure container using an invertible insert for removal by a user.

### SUMMARY

In some aspects, the techniques described herein relate to a container system for housing a specimen and a substance, including: a container body for receiving the specimen; a container lid selectively fastenable to the container body, the container lid and the container body forming a sealed enclosure when fastened together; a compartment extending from an underside of the container lid, the compartment retaining the substance when the compartment is sealed; a compartment film attached to the compartment, the compartment film sealing the substance in the compartment; and a piercing tool including an elongated body mounted in the container body and extending upwardly towards the container lid when the container lid is fastened to the container body, the piercing tool piercing the compartment film and releasing the substance into the container body when a predetermined pressure is applied to the compartment film by the piercing tool, wherein the piercing tool contacts the compartment film when the container lid and the container body are fully fastened together.

In some aspects, the techniques described herein relate to a container system, wherein the substance is a fixative for preserving the specimen when the substance is released into the container body and contacts the specimen.

In some aspects, the techniques described herein relate to a container system, wherein an interior wall of the container body from which the piercing tool protrudes is a bottom wall of the container body, the piercing tool extending perpendicularly upwardly from the bottom wall.

In some aspects, the techniques described herein relate to a container system, wherein the piercing tool includes: a face surface for dislodging the specimen from a deposition tool, wherein a first width of the piercing tool is smaller than a second width of an opening of the deposition tool, the deposition tool holding the specimen in the opening for placement in the container body.

In some aspects, the techniques described herein relate to a container system, further including: a stop selectively fastened to the container body, the stop preventing the container lid from fully fastening on the container body when fastened to the container body.

In some aspects, the techniques described herein relate to a container system, wherein the stop further includes a plurality of connectors connecting the stop to at least one of the container lid or the container body.

In some aspects, the techniques described herein relate to a container system, wherein a first connector from the plurality of connectors is connected to the container lid and a second connector from the plurality of connectors is connected to the container body when the container lid is partially fastened on the container body, wherein at least the first connector is disconnected from the container lid or the second connector is disconnected from the container body when the container lid is fully fastened on the container body.

In some aspects, the techniques described herein relate to a container system for housing a specimen and a substance, including: a container body for receiving the specimen; a container lid selectively fastenable to the container body, the container lid and the container body forming a sealed enclosure when fastened together; a film sealing the substance in at least one of the container body or the container lid; and a piercing tool including an elongated body extending towards the film when the container lid is fastened to the container body, the piercing tool piercing the film and releasing the substance into the sealed enclosure when a predetermined pressure is applied to the film by the piercing tool.

In some aspects, the techniques described herein relate to a container system, wherein the piercing tool protrudes upward from a sidewall of the container body, the piercing tool angled upward relative to a bottom wall of the container body, wherein the piercing tool contacts the film when the container lid and the container body are fully fastened together.

In some aspects, the techniques described herein relate to a container system, wherein the container lid includes a top wall, wherein the piercing tool protrudes from an underside of the top wall, the piercing tool contacting the film when the container lid and the container body are fully fastened together.

In some aspects, the techniques described herein relate to a container system, wherein the container lid includes an annular ring, the top wall hingedly connected to the annular ring, wherein the container lid and the container body are fully fastened together when the underside of the top wall abuts a topside of the annular ring.

In some aspects, the techniques described herein relate to a container system, wherein the container lid is hingedly connected to a distal end of the container body.

In some aspects, the techniques described herein relate to a container system, further including: lid threading attached to the container lid and extending from an underside of a top wall of the container lid; and body threading attached to the container body, wherein the lid threading and the body threading are rotationally fastenable such that the lid threading and the body threading fasten the container lid and the container body together.

In some aspects, the techniques described herein relate to a container system, further including: a reverse lid threading extending from a topside of the top wall of the container lid opposite of the lid threading, the reverse lid threading rotationally fastenable with the body threading such that the topside of the top wall faces outside of the container body when the reverse lid threading and the body threading are fastened together.

In some aspects, the techniques described herein relate to a container system for housing a specimen and a substance, including: a container body for receiving the specimen; a container lid selectively fastenable to the container body, the container lid and the container body forming a sealed enclosure when fastened together; a compartment extending from an underside of a top wall of the container lid, the compartment retaining the substance when the compartment is sealed; a compartment film attached to the compartment, the compartment film sealing the substance in the compartment; a piercing tool including an elongated body extending towards the compartment film when the container lid is fastened to the container body, the piercing tool piercing the compartment film and releasing the substance into the container body when a predetermined pressure is applied to the compartment film by the piercing tool, wherein the piercing tool contacts the compartment film when the container lid and the container body are fully fastened together; and a stop removably fastened to the container body, the stop preventing the container lid from fully fastening on the container body when fastened to the container body.

In some aspects, the techniques described herein relate to a container system, wherein the container lid and the container body form a liquid-tight system and a gas-tight system when the container lid is fastened on the container body.

In some aspects, the techniques described herein relate to a container system, wherein the substance includes a volatile organic compound, the volatile organic compound being formaldehyde.

In some aspects, the techniques described herein relate to a container system, wherein the stop is a ring fitted around the container body, the ring forming a physical blockage between the container lid and the container body.

In some aspects, the techniques described herein relate to a container system, further including: lid threading attached to the container lid and extending from the underside of the top wall of the container lid; and body threading attached to the container body, wherein the lid threading and the body threading are rotationally fastenable such that the sealed enclosure is formed between the container lid and the container body when the body threading and the lid threading are fully rotationally fastened.

In some aspects, the techniques described herein relate to a container system, wherein the lid threading of the container lid and the body threading are partially rotationally fastened when the stop is fastened to the container body.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIGS. 1A-1F illustrate an exemplary zero-exposure container system, in accordance with embodiments of the invention;

FIGS. 2A-2C illustrate an exemplary zero-exposure container system, in accordance with embodiments of the invention;

FIGS. 3A-3B illustrate an exemplary zero-exposure container system, in accordance with embodiments of the invention;

FIGS. 4A-4B illustrate an exemplary zero-exposure container system, in accordance with embodiments of the invention;

FIGS. 5A-5D illustrate an exemplary zero-exposure container system, in accordance with embodiments of the invention; and

FIG. 6 illustrates an exemplary zero-exposure container system, in accordance with embodiments of the invention.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

In general, embodiments of the invention relate to a container system for preventing the exposure of the environment external to the container system to a substance (such as formalin). The container system comprises a container body, a container lid selectively fastened to the container body, and a piercing tool provided within the container body. The container body and the container lid form a sealed enclosure when the container lid is fastened on the container body. The container body is hollowed to present a cup-shaped cavity for receiving a specimen (such as a tissue sample) and the substance. The container lid is hollowed to present a compartment for housing the substance. A compartment film overlays the compartment to seal the substance within the compartment of the container lid.

The piercing tool comprises an elongated body mounted within the container body and extending upwardly towards the container lid when the lid is fastened to the container body. The piercing tool's elongated body is of a length such that when the container lid is fastened to the container body, a distal end of the piercing tool interfaces with the compartment film. Responsive to the lid being fastened to the container body, a predetermined pressure is applied to the compartment film by the piercing tool to thereby pierce the film and release the substance into the container body's hollowed cavity.

The piercing tool may be mounted to an interior wall of the cavity of the container body, such as an interior bottom wall or interior side wall of the container body. For example, the piercing tool may be mounted to the interior bottom wall of the cavity such that the piercing tool extends perpendicularly upwardly from the bottom wall of the cavity and towards the fastened container lid. Alternatively, the piercing tool may be mounted to the interior side wall of the container body and extend at an acute angle upwardly towards the fastened container lid. The distal end of the piercing tool may include a face scrapable by a deposition tool (such as a pair of forceps) for releasing the specimen from the deposition tool.

### Zero-Exposure Container System

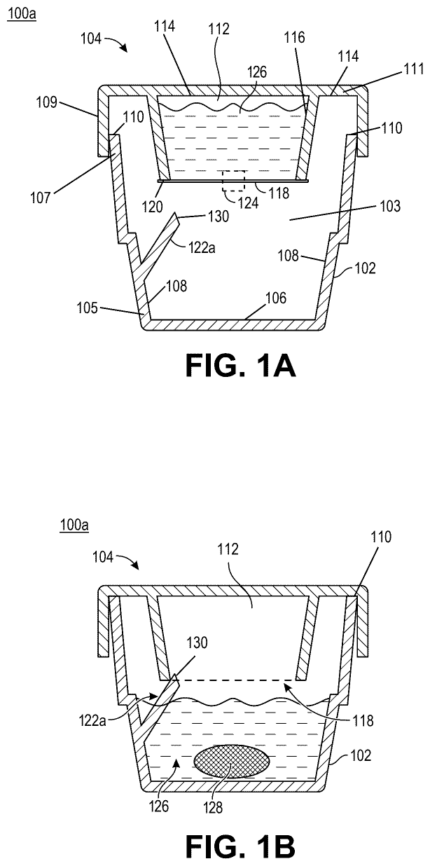

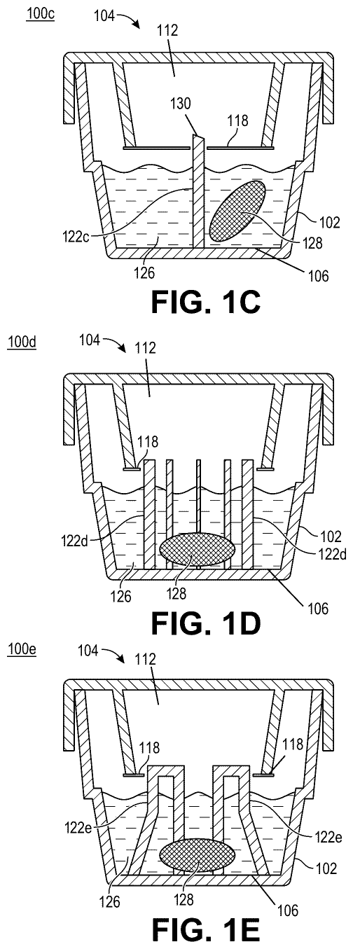

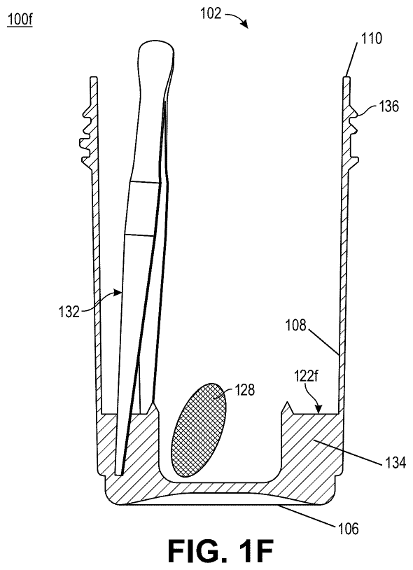

FIGS. 1A-1F illustrate exemplary zero-exposure container systems, in accordance with embodiments of the invention and generally referred to by reference numeral 100. Broadly, container system 100 encapsulates a specimen and a substance for zero-exposure handling and transportation. Container system 100 prevents the specimen and any contained substances (such as formalin) from being exposed to the environment outside of container system 100. For example, container system 100 prevents individuals handling container system 100 from being exposed to the specimen and the contained substances by forming a gas-tight system and/or a liquid-tight system.

Container system 100 includes container body 102 and container lid 104. Generally, container body 102 is hollowed to present a cavity formed from bottom wall 106 and at least one sidewall 108 extending upward from bottom wall 106. In embodiments where container body 102 is generally cylindrical in shape, sidewall 108 is an endless wall circumferentially enclosing bottom wall 106. In other embodiments where container body 102 is of non-cylindrical shape, there may be one or more sidewalls extending upwardly from bottom wall 106. Sidewall 108 includes proximal end 105 of sidewall 108 proximate to bottom wall 106 and an opposed distal end 107 proximate to container lid 104 when container lid 104 is fastened to container body 102.

Container body 102 and container lid 104 are formed from any suitable material now known or later developed, including, but not limited to, plastic, silicon, glass, and any other material. For example, container body 102 and container lid 104 may be formed from high-density polyethylene (HDPE) or polypropylene. The volume of container body 102 is any size, including, but not limited to, 5 ml, 10 ml, 15 ml, 25 ml, 30 ml, 50 ml, 60 ml, 100 ml, 120 ml, 150 ml, 200 ml, 250 ml, 500 ml, and 1 L. The volume of container body 102 may be selectively chosen to hold a specimen and accompanying substances, such as a fixative. In some embodiments, the volume of container body 102 is larger than the specimen within container body 102 (as discussed below), such as at least ten times larger.

Sidewall 108 includes rim 110 located on distal end 107 of sidewall 108. In some embodiments, container lid 104 is a sufficient diameter to fit around rim 110 of container body 102. For example, as described further below, annular ring 109 of container lid 104 may be a sufficient diameter to threadedly fasten around distal end 107 of container body 102. Container body 102 and container lid 104 fasten together to create a sealed enclosure. A sealed enclosure is an enclosure in which the contents within the sealed enclosure (such as liquids or gaseous substances) cannot escape into the environment external to the sealed enclosure. For example, if formalin is placed in the sealed enclosure formed by container body 102 and container lid 104, the formalin is prevented from escaping to the surrounding environment.

In some embodiments, container lid 104 includes annular ring 109 integrally formed with top wall 111. Annular ring 109 may be integrated into a side of top wall 111, such as underside 114. It should be appreciated that ring 109 may take on any shape (as viewed from a top view), such as circular, elliptical, oblong, or other shape to match a shape of a top of the cup. In some embodiments, container lid 104 includes a compartment 112 on underside 114 of top wall 111, underside 114 of top wall 111 being located inside the sealed enclosure formed by container lid 104 and container body 102 when container lid 104 is fastened to container body 102. Compartment 112 is hollowed to present a cavity formed from underside 114 of top wall 111 and compartment sidewall 116 extending downwardly from underside 114 of top wall 111. In embodiments where compartment 112 is generally cylindrical in shape, compartment sidewall 116 is an endless wall circumferentially enclosing at least a portion of underside 114. In other embodiments where compartment 112 is of non-cylindrical shape, there may be one or more sidewalls extending downwardly from underside 114. Compartment sidewall 116 includes a proximal end of compartment sidewall 116 proximate to underside 114 and an opposed distal end proximate to container body 102 when container lid 104 is fastened to container body 102.

The distal end of compartment sidewall 116 includes compartment rim 120. Compartment film 118 may be located at the distal end of compartment sidewall 116, the outer circumference of compartment film 118 attaching to compartment rim 120 (such as by an adhesive) to cover the cavity presented by compartment 112. Accordingly, when compartment film 118 is intact (i.e., contains no pierces, holes, or breakages), compartment 112 is a sealed enclosure such that the contents within compartment 112 are not exposed to the environment external to compartment 112. Subsequently, when compartment film 118 is broken (e.g., punctured, pierced, etc.), the contents of compartment 112 are released into the environment surrounding compartment 112.

Compartment film 118 is formed from any material suitable for selectively piercing, including, but not limited to, rubber, plastic, silicon, or paper. In some embodiments, however, compartment film 118 may be of sufficient strength to remain intact when a pressure below a predetermined pressure threshold is placed on compartment film 118, such as a press of a finger on the surface of compartment film 118 when a user is holding container lid 104. Nevertheless, compartment film 118 may be formed from a material of a suitable strength and thickness to be selectively broken when a sufficient pressure is applied with a particular object (such as piercing tool 122 discussed below).

In some embodiments, only a portion of compartment film 118 is selectively pierceable by piercing tool 122 when a predetermined pressure is applied by piercing tool 122. For example, middle portion 124 of compartment film 118 may be selectively pierceable by piercing tool 122 when a pressure meeting or exceeding a predetermined amount of pressure is administered to any part of middle portion 124 of compartment film 118 by piercing tool 122. Accordingly, the remainder of compartment film 118 may be un-pierceable by piercing tool 122 when a substantially similar amount of pressure is applied to any part of the remainder of compartment film 118. In some embodiments, the entirety of compartment film 118 is selectively pierceable by piercing tool 122 when a predetermined pressure is applied or exceeded by piercing tool 122. In some embodiments, substance 126 is sealed in compartment 112 when compartment film 118 is intact.

Generally, substance 126 is any substance now known or later developed, including, but not limited to, any liquid or gas. In some embodiments, substance 126 contains a substance that is toxic and/or harmful to humans upon exposure to substance 126, such as formaldehyde in formalin. As such, by sealing substance 126 in compartment 112 when compartment film 118 is intact, substance 126 is prevented from entering the environment surrounding compartment 112 and thus causing harm. In some embodiments, substance 126 is a volatile organic compound, such as formaldehyde.

In some embodiments, piercing tool 122 punctures compartment film 118 when in contact with compartment film 118 with a predetermined amount of pressure applied to or exceeded by piercing tool 122 against compartment film 118. Thus, as depicted in FIG. 1A, piercing tool 122 may be prevented from coming into contact with compartment film 118 before a sealed enclosure is formed between container body 102 and container lid 104. For example, piercing tool 122 may not be of sufficient length to come into contact with compartment film 118 when container lid 104 is not fully fastened on container body 102, where fully fastening container lid 104 on container body 102 may be defined by abutting rim 110 to underside 114 and/or fully threading the threads of container body 102 and container lid 104 together (as discussed below). As such, when container lid 104 is fully fastened on container body 102 (as depicted in FIG. 1B), piercing tool 122 may pierce compartment film 118, causing substance 126 to be released from compartment 112 into container body 102. Accordingly, upon substance 126 being released into container body 102, substance 126 may contact specimens within container body 102, such as specimen 128.

Broadly, specimen 128 is a sample placed within container body 102 of container system 100. Specimen 128 may be a tissue sample, biological sample, or similar types of samples. For example, specimen 128 may be placed in container body 102 by a user for storage and transportation of specimen 128. As such, by releasing substance 126 into container body 102 when specimen 128 is located within container body 102, substance 126 contacts specimen 128, which may have one or more effects on specimen 128. For example, if substance 126 is a fixative (like formalin), substance 126 preserves specimen 128 for testing when substance 126 comes into contact with specimen 128.

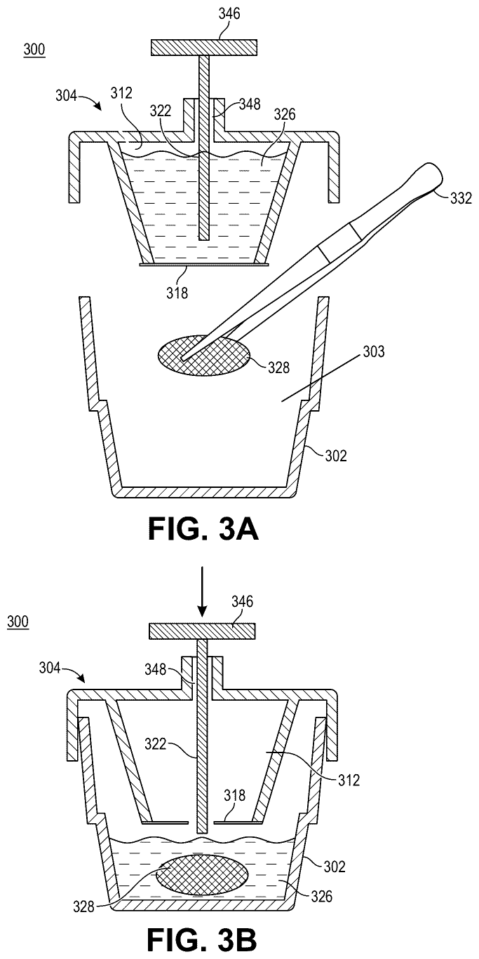

In some embodiments, piercing tool 122 comprises an elongated body mounted within container body 102 for piercing compartment film 118 and, therefore, unsealing compartment film 118. Piercing tool 122a may extend upwardly towards container lid 104 when container lid 104 is fastened to container body 102. The length of piercing tool 122 may be such that when container lid 104 is fully fastened to container body 102, distal end 130 of piercing tool 122 interfaces with compartment film 118. In some embodiments, responsive to container lid 104 being fastened to container body 102, a predetermined pressure is applied to compartment film 118 by piercing tool 122 to thereby pierce compartment film 118 and release substance 126 into cavity 103 of container body 102. In other embodiments, responsive to a downward force (such as a downward force applied by handle 346 depicted in FIGS. 3A-3B), a predetermined pressure is applied to compartment film 118 by piercing tool 122 to thereby pierce compartment film 118 and release substance 126 into cavity 103 of container body 102.

Piercing tool 122 may be any shape now known or later developed for piercing compartment film 118 when a predetermined amount of pressure is applied to compartment film 118 by piercing tool 122, including, but not limited to, points, spikes, cylinders, razor blades, pyramids, or any combination herein. For example, as depicted in FIGS. 1A-1B, piercing tool 122a may be an elongated cylinder or rectangle with distal end 130 ending in a point or spike. For another example, as illustrated in FIG. 1E, piercing tool 122e may be a razor-blade-shaped body.

In some embodiments, as depicted in FIGS. 1A-1B, piercing tool 122a is angularly mounted to the interior of sidewall 108 of cavity 103. Accordingly, piercing tool 122a may be angled relative to bottom wall 106 of container body 102 such that, when container lid 104 is fully fastened on container body 102, distal end 130 of piercing tool 122a pierces compartment film 118. In some embodiments, as depicted in FIGS. 1C-1D, piercing tool 122 protrudes from bottom wall 106 of container body 102. For example, as depicted in FIG. 1C, piercing tool 122c extends perpendicularly upwardly from bottom wall 106 of container body 102 and towards container lid 104. In some embodiments, piercing tool 122 is a singular elongated body, such as piercing tool 122a depicted in FIG. 1A. In other embodiments, piercing tool 122 is a plurality of elongated bodies, such as piercing tool 122d depicted in FIG. 1D.

In some embodiments, as depicted in FIG. 1F, piercing tool 122f includes face 134 defined by a side of the body of piercing tool 122f. For example, piercing tool 122f may be a wall-like body extending the diameter of container body 102, where face 134 is extending upwardly perpendicularly to bottom wall 106. In such embodiments, piercing tool 122f includes a width, where if the width of piercing tool 122f is smaller than the width of the opening of deposition tool 132 holding of specimen 128, deposition tool 132 may be placed over piercing tool 122f such that piercing tool 122f is within the opening of deposition tool 132. Accordingly, deposition tool 132 may be scraped along face 134 of piercing tool 122f, thereby dislodging specimen 128 from deposition tool 132.

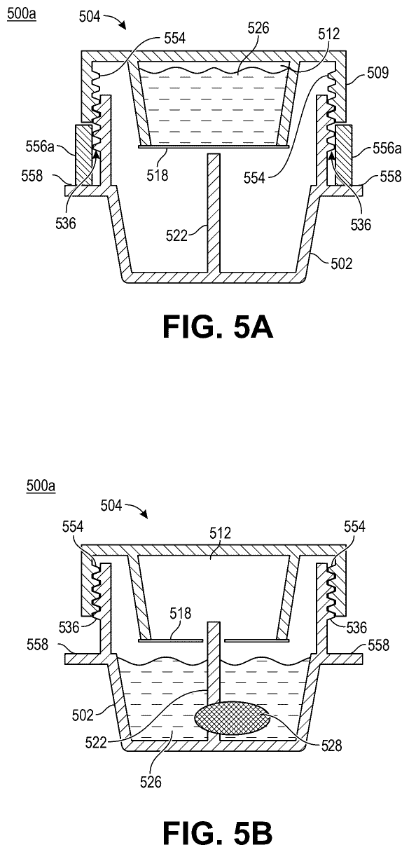

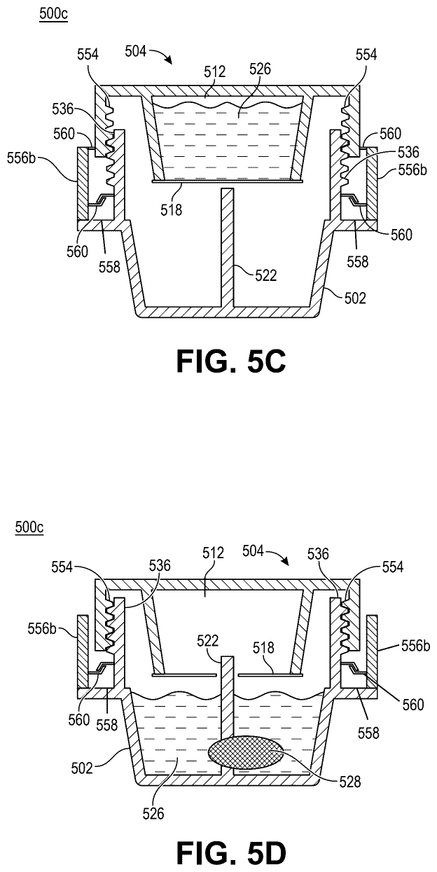

In some embodiments, as discussed further below, container body 102 and container lid 104 include threading for fastening container lid 104 on container body 102. For example, container body 102 may contain body threading 136 extending downward toward bottom wall 106 from rim 110 of container body 102. Subsequently, the container lid 104 associated with container body 102 may include threading pairable to that of body threading 136, allowing container lid 104 to be rotationally fastened to container body 102. The rotation fastening of container lid 104 on container body 102 may initiate the contact of piercing tool 122 to compartment film 118, causing piercing tool 122 to pierce compartment film 118 and thereby releasing substance 126 from compartment 112 into container body 102. For example, piercing tool 122 may pierce compartment film 118 when body threading 136 is transitioned from being partially connected to the threading of container lid 104 (as depicted by container system 500 in FIG. 5A) to being fully connected to the threading of container body 102 (as depicted by container system 500 in FIG. 5B).

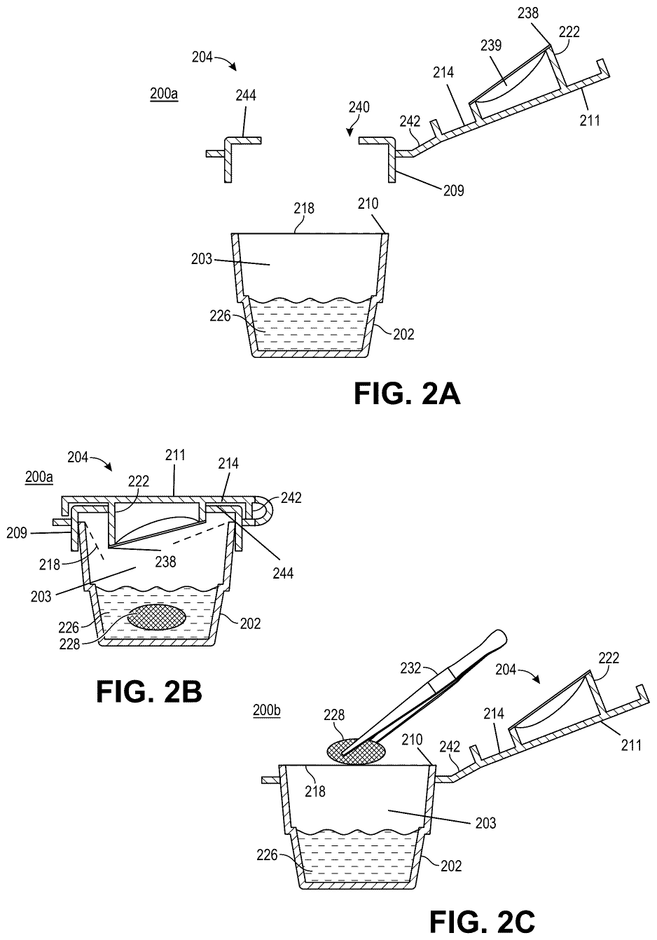

It is noted herein that any other fastening mechanism may be used to secure container lid 104 to container body 102, including, but not limited to snapping, clicking, latching, and hinging. In such embodiments, the fastening of container lid 104 to container body 102 may result in piercing tool 122 piercing compartment film 118. For example, using FIGS. 2A-2C to illustrate, container lid 204 (generally related to container lid 104) may suction to container body 202 (generally related to container body 102) upon placing container lid 204 on container body 202 with pressure, the suction creating a seal between container body 202 and container lid 204 to secure container body 202 and container lid 204 together.

FIGS. 2A-2C illustrate exemplary zero-exposure container systems, in accordance with embodiments of the invention and generally referred to by reference numeral 200. Generally, container system 200, in a similar manner to container system 100, includes a sealed cavity 203 formed by container body 202 and container lid 204, preventing environmental exposure to substance 226 (generally related to substance 126) and specimen 228 (generally related to specimen 128) when container body 202 and container lid 204 are fastened together.

In some embodiments, as described above with regard to container body 102 depicted in FIG. 1A, container body 202 is hollowed to present a cup-shaped cavity 203 for receiving specimen 228 and substance 226. The volume of container body 202 may be any size, including, but not limited to, 5 ml, 10 ml, 15 ml, 25 ml, 30 ml, 50 ml, 60 ml, 100 ml, 120 ml, 150 ml, 200 ml, 250 ml, 500 ml, and 1 L. The volume of container body 202 may be selectively chosen to hold a specimen and accompanying substances, such as a fixative.

In some embodiments, compartment film 218 (generally related to compartment film 118) overlays the opening of cavity 203 of container body 202, creating a sealed compartment in cavity 203 of container body 202 when compartment film 218 is intact. In such embodiments, rim 210 (generally related to rim 110 discussed above) of container body 202 may include an adhesive for securing the edges of compartment film 218 to rim 210, creating a sealed compartment. Accordingly, the sealed compartment of container body 202 may be prefilled with substance 226, preventing substance 226 from contacting the environment surrounding container system 200.

In some embodiments, compartment film 218 is of sufficient strength to remain intact when specimen 228 is placed on top of compartment film 218 such that specimen 228 applies a downward force to compartment film 218, as depicted in FIG. 2C. For example, specimen 228 may be placed on compartment film 218 using deposition tool 232 (generally related to deposition tool 132) prior to compartment film 218 being pierced. As such, compartment film 218 may be of sufficient strength to remain intact, thereby supporting specimen 228 on the surface of compartment film 218 with substance 226 remaining sealed within container body 202.

The container lid 204 is selectively fastenable to the container body 202, i.e., a user can select to fasten or de-fasten the lid to the container body. FIG. 2A illustrates the container lid 204 in an open configuration and de-fastened from the container body 202, and FIG. 2B illustrates the same container lid 204 in a closed configuration and fastened to the container body 202. When container body 202 and container lid 204 are selectively fastened together, container body 202 and container lid 204 form a sealed enclosure. In the embodiment of FIGS. 2A and 2B, and similar to the embodiment described above with regard to FIG. 1A, container lid 204 includes annular ring 209 and top wall 211, generally related to annular ring 109 and top wall 111, respectively. As depicted in container system 200a of FIG. 2A, top wall 211 may be hingedly connected to annular ring 209 via hinge 242, such that top wall 211 cannot be decoupled (e.g., separated) from annular ring 209. As depicted in FIG. 2B, container body 202 and container lid 204 are fully fastened together when underside 214 of top wall 211 abuts topside 244 of annular ring 209 and annular ring 209 is fastened to container body 202. Container lid 204 may be selectively fastenable to container body 202 such that container lid 204 and container body 202 are separate components when unfastened from one another.

FIG. 2C depicts container system 200b that comprises container lid 204 including top wall 211, where top wall 211 is hingedly connected to container body 202 via hinge 242, such that top wall 211 cannot be decoupled (i.e., separated) from container body 202. The container lid 204 of the embodiment of FIG. 2C does not include annular ring 209. In the FIG. 2C embodiment, underside 214 of top wall 211 contacts rim 210 when container lid 204 and container body 202 are fully fastened together. Container lid 204 may remain hingedly connected to container body 202 via hinge 242 when container lid 204 and container body 202 are unfastened from one another.

In some embodiments, container lid 204 includes piercing tool 222 (generally related to piercing tool 122 in FIG. 1A), the elongated body of piercing tool 222 mounted to and extending from underside 214 of top wall 211. Piercing tool 222 is an elongated body for piercing compartment film 218 when piercing tool 222 contacts compartment film 218 and a predetermined amount of pressure (or an amount of pressure greater than the predetermined amount) is applied to compartment film 218 by piercing tool 222. As such, piercing tool 222 may be of a length and shape such that piercing tool 222 pierces compartment film 218 when piercing tool 222 extends through opening 240. For example, piercing tool 222 may be a spike, blade, prism structure, etc., extending from underside 214 and ending in a sharp edge for puncturing compartment film 218. For another example, piercing tool 222 may be an elongated body ending in a blunt edge, such as the cylindrical body of piercing tool 322 discussed below, where a predetermined amount of force causes piercing tool 222 to puncture compartment film 218.

In some embodiments, as depicted in FIG. 2A, piercing tool 222 is a ring-shaped protrusion angled relative to top wall 211 to form leading edge 238, where leading edge 238 is defined by the point extending the furthest from underside 214 of top wall 211 relative to the remaining points of piercing tool 222. As described further below, leading edge 238 may be the first portion of piercing tool 222 to contact compartment film 218 when fully fastening container body 202 and container lid 204 together. In some embodiments, piercing tool 222 may include cup 239, where cup 239 is a concave space within the circumference of piercing tool 222. When contacting compartment film 218 with piercing tool 222, specimen 228 may be received in cup 239, cup 239 preventing specimen 228 from being contacted (and damaged) by piercing tool 222.

In some embodiments, container lid 204 includes opening 240, sufficiently sized for receiving piercing tool 222 when annular ring 209 is fastened on container body 202 and top wall 211 is folded relative to annular ring 209. To illustrate, after specimen 228 is placed on compartment film 218, such as by deposition tool 232 (as depicted in FIG. 2C), top wall 211 may be folded at hinge 242 relative to annular ring 209. Subsequently, as depicted in FIG. 2B, when top wall 211 is fully folded relative to annular ring 209 and annular ring 209 is fastened to container body 202, piercing tool 222 extends through opening 240, making contact with and applying pressure to compartment film 218 such that an opening forms in compartment film 218. For example, leading edge 238 of piercing tool 222 may first contact and apply pressure to compartment film 218, with the remainder of piercing tool 222 contacting compartment film 218 after leading edge 238 to create an opening in compartment film 218 large enough for specimen 228 to fall through. Subsequently, specimen 228 falls into the sealed enclosure formed between container lid 204 and container body 202.

FIGS. 3A-3B illustrate exemplary zero-exposure container systems, in accordance with embodiments of the invention and generally referred to by reference numeral 300. Broadly, container system 300 is a plunger-based system for releasing a substance into cavity 303, generally related to cavity 103 depicted in FIG. 1A, preventing the release of the substance into the environment surrounding container system 300. In some embodiments, container system 300 includes container body 302 and container lid 304, generally relating to container body 102 and container lid 104 depicted in FIG. 1A. Container lid 304 may include compartment 312 and compartment film 318, generally relating to compartment 112 and compartment film 118 depicted in FIG. 1A.

In some embodiments, container system 300 includes handle 346 mounted to piercing tool 322 such that piercing tool 322 abuts at least one side of handle 346. Piercing tool 322 generally relates to piercing tool 122 and piercing tool 222 described above. Handle 346 may be located externally to compartment 312 and piercing tool 322 may partially extend into compartment 312 through opening 348 in container lid 304. Handle 346 is an elongated body for applying downward force (e.g., a force toward compartment film 318) to piercing tool 322 such that piercing tool 322 is driven further downward into compartment 312 and toward compartment film 318. Handle 346 may be circular, rectangular, or any other shape for receiving and applying a downward force.

Compartment 312 may house substance 326, generally relating to substance 126 depicted in FIG. 1A. Opening 348 may seal around piercing tool 322 such that substance 326 is sealed within container system 300 and, therefore, not exposed to the environment surrounding container system 300. In some embodiments, a downward force applied to handle 346 causes piercing tool 322 to move downward. In such embodiments, opening 348 may remain sealed around piercing tool 322, preventing exposure to substance 326 during movement and rest of piercing tool 322.

In some embodiments, a downward force applied to handle 346 causes piercing tool 322 to pierce compartment film 318. For example, as illustrated in FIG. 3A, specimen 328 may be placed in container body 302 using deposition tool 332, generally related to deposition tool 132. Upon placement of specimen 328 in container body 302, container lid 304 may be fastened on container body 302 such that a sealed compartment is formed between container lid 304 and container body 302. Upon fastening container lid 304 on container body 302, a downward force may be applied to handle 346, causing downward movement of piercing tool 322, as depicted in FIG. 3B. The downward force may then cause piercing tool 322 to make contact with and apply pressure to compartment film 318, piercing compartment film 318. Upon the piercing of compartment film 318, substance 326 may drain from compartment 312 into container body 302, making contact with specimen 328.

### Film Piercing Prevention

Broadly, a container system may include one or more safety elements for use of the container system, such as to prevent the premature puncturing of the compartment film of the container system by a piercing tool. For example, a zero-exposure container may be enclosed in plastic wrap, preventing movement of the container lid and container body before the removal of the plastic wrap, therefore preventing the inadvertent piercing of the compartment film of the compartment of the container lid. For another example, a container system may include one or more auditory or visual signals (as discussed below) for displaying whether the container system is overfilled, the container body and the container lid have been sealed together, and any other piece of information about the container system.

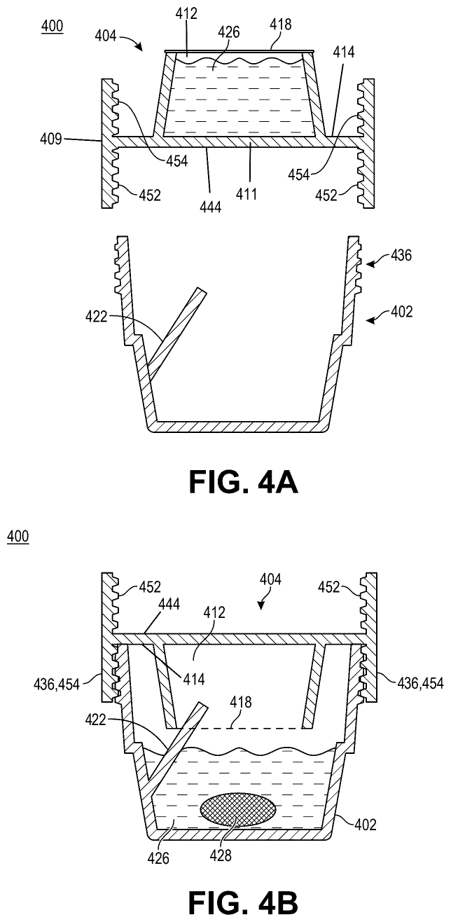

FIGS. 4A-4B illustrate exemplary zero-exposure container systems, in accordance with embodiments of the invention and generally referred to by reference numeral 400. Container system 400 may be substantially similar to container system 100 described above. For example, container system 400 may be a zero-exposure container system for preventing environmental exposure to substance 426, generally related to substance 126 depicted in FIG. 1A, when combining substance 426 with specimen 428, generally related to specimen 128 depicted in FIG. 1B. Container system 400 includes container body 402, container lid 404, compartment 412, compartment film 418, substance 426, and piercing tool 422, generally related to container body 102, container lid 104, compartment 112, compartment film 118, substance 126, and piercing tool 122, respectively.

Generally, compartment 412 housing substance 426 remains sealed until body 402 and container lid 404 are fastened together in such a way that compartment film 418 is broken by piercing tool 422 (e.g., when container body 402 and container lid 404 form a seal). Upon releasing substance 426 by breaking compartment film 418, substance 426 flows into the sealed enclosure formed by the fastening of container lid 404 to container body 402, thus sealing substance 426 from the surrounding environment.

As discussed above regarding container system 100, container body 402 may include body threading 436, generally related to body threading 136 depicted in FIG. 1F. Accordingly, annular ring 409 (generally related to annular ring 109) of container lid 404 may contain threading extending from topside 414 of top wall 411 (generally related to top wall 111) with a matching pattern to the pattern of body threading 436 such that container lid 404 secures on container body 402 with compartment 412 facing toward container body 402 when body threading 436 of container body 402 and lid threading 454 of annular ring 409 are threaded together. In some embodiments, in order to prevent the inadvertent release of substance 426 before container body 402 and container lid 404 form a sealed enclosure, annular ring 409 may include reverse lid threading 452 extending from topside 444 of top wall 411 with a matching pattern to the pattern of body threading 436. As such, when reverse lid threading 452 and body threading 436 are threadedly fastened together, compartment 412 faces outward from container body 402 to prevent the piercing of compartment film 418 by piercing tool 422.

To store specimen 428 with substance 426 by releasing substance 426 into container body 402, container lid 404 may be removed from container body 402 by unscrewing reverse lid threading 452 from body threading 436. Subsequently, specimen 428 may be placed in container body 402. In some embodiments, in order to release substance 426 from compartment 412 by breaking compartment film 418, container lid 404 is inverted such that compartment 412 is facing inward toward container body 402. As discussed above, annular ring 409 may include lid threading 454 extending from underside 414, generally related to underside 114 depicted in FIG. 1A, of container lid 404. As such, when lid threading 454 is fastened to body threading 436, compartment film 418 of compartment 412 may be pierced by piercing tool 422, thereby releasing substance 426 into the sealed compartment formed by container lid 404 and container body 402.

FIGS. 5A-5D illustrates exemplary zero-exposure container systems in accordance with embodiments of the invention and are generally referred to by reference numeral 500. Container system 500 and the components of container system 500 may be substantially similar to container system 100 and the components of container system 100 described above. For example, container system 500 may be a container system for preventing environmental exposure to substance 526, generally related to substance 126 depicted in FIG. 1A, while combining substance 526 with specimen 528, generally related to specimen 128 depicted in FIG. 1B, with container body 502, generally related to container body 102 depicted in FIG. 1A. Container system 500 includes container body 502, container lid 504, compartment 512, compartment film 518, and piercing tool 522, generally related to container body 102, container lid 104, compartment 112, compartment film 118, and piercing tool 122, respectively, as described with regard to container system 100.

In some embodiments, as depicted in FIG. 5A, lid threading 554, generally related to lid threading 454 depicted in FIG. 4A, of container lid 504 is prevented from fully fastening with body threading 536, generally related to body threading 136 depicted in FIG. 1F, of container body 502 by a selectively removable stop 556a located above container lip 558. Stop 556a may form a physical blockage between container body 502 and container lid 504 such that compartment 512 extending downward into container body 502 is prevented from contacting piercing tool 522. For example, the top edge of stop 556a may contact the bottom edge of annular ring 509 (generally related to annular ring 109) when container lid 504 is partially fastened on container body 502 and stop 556a is fitted around container body 502. Thus, stop 556a prevents the breakage of compartment film 518 by piercing tool 522. Stop 556a may be a tab, ring, wedge, or other physical structure fitted over container body 502.

A user may selectively remove stop 556a when the user desires to fully fasten container lid 504 to container body 502. For example, container lid 504 may be unfastened from container body 502 to add specimen 528 to container body 502, as depicted in FIG. 5B. In such an example, stop 556a may be removed when container lid 504 is unfastened from container body 502. When stop 556a is removed, as depicted in FIG. 5B, lid threading 454 and body threading 536 may fully fasten together, and piercing tool 522 may pierce compartment film 518 such that substance 526 is released into the sealed compartment formed between container lid 504 and container body 502, as described above with regard to the components of container system 100 of FIGS. 1A-1F.

In some embodiments, stop 556a rests on container lip 558. In some embodiments, as depicted in FIG. 5C, stop 556b is connected to one or more connectors of container system 500c. For example, connector 560 may connect the top edge of stop 556b to the face opposite of lid threading 554. For another example, connector 560 may connect body threading 536 of container body 502 to stop 556b. By connecting stop 556b to container lid 504 and container body 502, container lid 504 may be prevented from inadvertently rotationally fastening to container body 502 and causing piercing tool 522 to pierce compartment film 518 and release substance 526 when specimen 528 has not been placed in container body 502 and/or container lid 504 is not fully sealed on container body 502.

When container lid 504 is rotationally unfastened from container body 502, connector 560 may disconnect from stop 556b, container lid 504, and/or container body 502 to allow container lid 504 to rotate and be removed. Upon removal, as depicted in FIG. 5D, specimen 528 may be placed within container body 502 and container lid 504 may be replaced and rotationally fastened to container 502, causing a sealed enclosure to form between container body 502 and container lid 504. Additionally, upon threadedly fastening container lid 504 to container body 502, piercing tool 522 may puncture compartment film 518 such that substance 526 drains into container body 502 and contacts specimen 528. Beyond preventing the inadvertent rotation of container lid 504 on container body 502, connector 560 may provide a visual indication to a user that container lid 504 has or has not been rotatably fastened to container body 502. Accordingly, a user may visually verify if substance 526 has been released from compartment 512 based on whether connector 560 is attached to container body 502 and container lid 504.

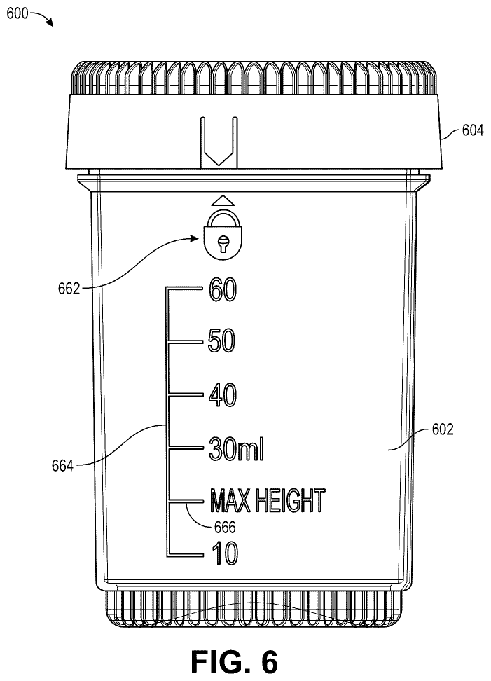

FIG. 6 illustrates an exemplary zero-exposure container system, in accordance with embodiments of the invention and generally referred to by reference numeral 600. Container system 600 and the components of container system 600 are substantially similar to container system 100 and the components of container system 100 described above. For example, container system 600 may be a container system for preventing environmental exposure of a substance combined with a specimen, such as formalin combined with a tissue sample. Container system 600 includes container body 602 and container lid 604, generally relating to container body 102 and container lid 104 depicted in FIGS. 1A-1F, respectively. Additionally, container system 600 may include a compartment with a compartment film for retaining the substance prior to piercing the film and a piercing tool for breaking the film to release the substance into the sealed compartment formed by container body 602 and container lid 604.

In some embodiments, container system 600 includes visual markers and/or auditory markers to prevent misuse of container system 600. For example, container system 600 may include seal indicator 662, such as an icon in the shape of a lock. Seal indicator 662 may give a user a visual indication when container lid 604 is secured to container body 602 such that container lid 604 and container body 602 form a sealed compartment, thus preventing the contents inside the sealed compartment from contact with the surrounding environment. For another example, container system 600 may emit audible clicks when container lid 604 is fully fastened to container body 602.

In some embodiments, container system 600 includes fill gauge 664. Fill gauge 664 may give a visual indication to a user regarding the volume of contents within container system 600. Fill gauge 664 may be a visual indicator to a user that a specimen is too large for container system 600, too much of a substance has been added to container system 600, too little of a substance has been added to container system 600, and the like. In some embodiments, container system 600 includes max volume 666, indicating the max volume for which the cup may be filled without damage to the specimen and/or the overflowing of container system 600.

Features described above as well as those claimed below may be combined in various ways without departing from the scope hereof. The following examples illustrate some possible, non-limiting combinations:

Clause 1. A container system for housing a specimen and a substance, comprising: a container body for receiving the specimen; a container lid selectively fastenable to the container body, the container lid and the container body forming a sealed enclosure when fastened together; a compartment extending from an underside of the container lid, the compartment retaining the substance when the compartment is sealed; a compartment film attached to the compartment, the compartment film sealing the substance in the compartment; and a piercing tool comprising an elongated body mounted in the container body and extending upwardly towards the container lid when the container lid is fastened to the container body, the piercing tool piercing the compartment film and releasing the substance into the container body when a predetermined pressure is applied to the compartment film by the piercing tool, wherein the piercing tool contacts the compartment film when the container lid and the container body are fully fastened together.

Clause 2. The container system of clause 1, wherein the substance is a fixative for preserving the specimen when the substance is released into the container body and contacts the specimen.

Clause 3. The container system of clause 1 or clause 2, wherein an interior wall of the container body from which the piercing tool protrudes is a bottom wall of the container body, the piercing tool extending perpendicularly upwardly from the bottom wall.

Clause 4. The container system of any of clause 1 through clause 3, wherein the piercing tool comprises: a face surface for dislodging the specimen from a deposition tool, wherein a first width of the piercing tool is smaller than a second width of an opening of the deposition tool, the deposition tool holding the specimen in the opening for placement in the container body.

Clause 5. The container system of any of clause 1 through clause 4, further comprising: a stop removably fastened to the container body, the stop preventing the container lid from fully fastening on the container body when fastened to the container body.

Clause 6. The container system of any of clause 1 through clause 5, wherein the stop further comprises a plurality of connectors connecting the stop to at least one of the container lid and or the container body.

Clause 7. The container system of any of clause 1 through clause 6, wherein a first connector from the plurality of connectors is connected to the container lid and a second connector from the plurality of connectors is connected to the container body when the container lid is partially fastened on the container body, wherein at least the first connector is disconnected from the container lid or the second connector is disconnected from the container body when the container lid is fully fastened on the container body.

Clause 8. A container system for housing a specimen and a substance, comprising: a container body for receiving the specimen; a container lid selectively fastenable to the container body, the container lid and the container body forming a sealed enclosure when fastened together; a compartment extending from an underside of the container lid, the compartment retaining the substance when the compartment is sealed; a compartment film attached to the compartment, the compartment film sealing the substance in the compartment; and a piercing tool comprising an elongated body extending towards the container lid when the container lid is fastened to the container body, the piercing tool piercing the compartment film and releasing the substance into the container body when a predetermined pressure is applied to the compartment film by the piercing tool.

Clause 9. The container system of clause 8, wherein the piercing tool protrudes upward from a sidewall of the container body, the piercing tool angled upward relative to a bottom wall of the container body, wherein the piercing tool contacts the compartment film when the container lid and the container body are fastened together.

Clause 10. The container system of clause 8 or clause 9, wherein the substance comprises formalin and the specimen comprises a tissue sample, the formalin preserving the tissue sample when in contact with the tissue sample.

Clause 11. The container system of any of clause 8 through clause 10, further comprising: the piercing tool, a portion of the piercing tool partially extending into the compartment; and a handle external to the compartment for applying a downward force on the piercing tool, wherein applying the predetermined pressure on the handle causes the piercing tool to pierce the compartment film and release the substance into the container body.

Clause 12. The container system of any of clause 8 through clause 11, wherein the portion of the piercing tool is sealed within the compartment when the portion of the piercing tool extends into the compartment.

Clause 13. The container system of any of clause 8 through clause 12, further comprising: lid threading attached to the container lid and extending from an underside of a top wall of the container lid; and body threading attached to the container body, wherein the lid threading and the body threading are rotationally fastenable such that the lid threading and the body threading fasten the container lid and the container body together.

Clause 14. The container system of any of clause 8 through clause 13, further comprising: a reverse lid threading extending from a topside of the top wall of the container lid opposite of the lid threading, the reverse lid threading rotationally fastenable with the body threading such that the compartment extends outside of the container body when the reverse lid threading and the body threading are fastened together.

Clause 15. The container system of any of clause 8 through clause 14, wherein the container lid comprises a top wall, wherein the piercing tool protrudes from an underside of the top wall, the piercing tool contacting the film when the container lid and the container body are fully fastened together.

Clause 16. The container system of any of clause 8 through clause 15, wherein the container lid comprises an annular ring, the top wall hingedly connected to the annular ring, wherein the container lid and the container body are fully fastened together when the underside of the top wall abuts a topside of the annular ring.

Clause 17. The container system of any of clause 8 through clause 16, wherein the container lid is hingedly connected to a distal end of the container body.

Clause 18. A container system for housing a specimen and a substance, comprising: a container body for receiving the specimen; a container lid selectively fastenable to the container body, the container lid and the container body forming a sealed enclosure when fastened together; a compartment extending from an underside of a top wall of the container lid, the compartment retaining the substance when the compartment is sealed; a compartment film attached to the compartment, the compartment film sealing the substance in the compartment; a piercing tool comprising an elongated body extending towards the compartment film when the container lid is fastened to the container body, the piercing tool piercing the compartment film and releasing the substance into the container body when a predetermined pressure is applied to the compartment film by the piercing tool, wherein the piercing tool contacts the compartment film when the container lid and the container body are fastened together; and a stop removably fastened to the container body, the stop preventing the container lid from fully fastening on the container body when fastened to the container body.

Clause 19. The container system of clause 18, wherein the container lid and the container body form a liquid-tight system and a gas-tight system when the container lid is fastened on the container body.

Clause 20. The container system of clause 18 or clause 19, wherein the substance comprises a volatile organic compound, the volatile organic compound being formaldehyde.

Clause 21. The container system of any of clause 18 through clause 20,wherein the stop is a ring fitted around the container body, the ring forming a physical blockage between the container lid and the container body.

Clause 22. The container system of any of clause 18 through clause 21, further comprising: lid threading attached to the container lid and extending from the underside of the top wall of the container lid; and body threading attached to the container body, wherein the lid threading and the body threading are rotationally fastenable such that the sealed enclosure is formed between the container lid and the container body when the body threading and the lid threading are fully rotationally fastened.

Clause 23. The container system of any of clause 18 through clause 22,wherein the lid threading of the container lid and the body threading are partially rotationally fastened when the stop is fastened to the container body.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. A container system for housing a specimen and a substance, comprising:
a container body for receiving the specimen;
a container lid selectively fastenable to the container body, the container lid and the container body forming a sealed enclosure when fastened together;
a compartment extending from an underside of the container lid, the compartment retaining the substance when the compartment is sealed;
a compartment film attached to the compartment, the compartment film sealing the substance in the compartment; and
a piercing tool comprising an elongated body extending towards the compartment film when the container lid is fastened to the container body, the piercing tool piercing the compartment film and releasing the substance into the container body when a predetermined pressure is applied to the compartment film by the piercing tool.

2. The container system of claim 1,
wherein the substance is a fixative for preserving the specimen when the substance is released into the container body and contacts the specimen.

3. The container system of claim 1,
wherein an interior wall of the container body from which the piercing tool protrudes is a bottom wall of the container body, the piercing tool extending perpendicularly upwardly from the bottom wall.

4. The container system of claim 3,
wherein the piercing tool comprises:
a face surface for dislodging the specimen from a deposition tool,
wherein a first width of the piercing tool is smaller than a second width of an opening of the deposition tool, the deposition tool holding the specimen in the opening for placement in the container body.

5. The container system of claim 1, further comprising:
a stop selectively fastened to the container body, the stop preventing the container lid from fully fastening on the container body when fastened to the container body.

6. The container system of claim 5,
wherein the stop further comprises a plurality of connectors connecting the stop to at least one of the container lid or the container body.

7. The container system of claim 6,
wherein a first connector from the plurality of connectors is connected to the container lid and a second connector from the plurality of connectors is connected to the container body when the container lid is partially fastened on the container body,
wherein at least the first connector is disconnected from the container lid or the second connector is disconnected from the container body when the container lid is fully fastened on the container body.

8. A container system for housing a specimen and a substance, comprising:
a container body for receiving the specimen;
a container lid selectively fastenable to the container body, the container lid and the container body forming a sealed enclosure when fastened together;
a film sealing the substance in at least one of the container body or the container lid; and
a piercing tool comprising an elongated body extending towards the film when the container lid is fastened to the container body, the piercing tool piercing the film and releasing the substance into the sealed enclosure when a predetermined pressure is applied to the film by the piercing tool.

9. The container system of claim 8,
wherein the piercing tool protrudes upward from a sidewall of the container body, the piercing tool angled upward relative to a bottom wall of the container body,
wherein the piercing tool contacts the film when the container lid and the container body are fully fastened together.

10. The container system of claim 8,
wherein the container lid comprises a top wall,
wherein the piercing tool protrudes from an underside of the top wall, the piercing tool contacting the film when the container lid and the container body are fully fastened together.

11. The container system of claim 10,
wherein the container lid comprises an annular ring, the top wall hingedly connected to the annular ring,
wherein the container lid and the container body are fully fastened together when the underside of the top wall abuts a topside of the annular ring.

12. The container system of claim 10,
wherein the container lid is hingedly connected to a distal end of the container body.

13. The container system of claim 8, further comprising:
lid threading attached to the container lid and extending from an underside of a top wall of the container lid; and
body threading attached to the container body,
wherein the lid threading and the body threading are rotationally fastenable such that the lid threading and the body threading fasten the container lid and the container body together.

14. The container system of claim 13, further comprising:
a reverse lid threading extending from a topside of the top wall of the container lid opposite of the lid threading,
the reverse lid threading rotationally fastenable with the body threading such that the topside of the top wall faces outside of the container body when the reverse lid threading and the body threading are fastened together.

15. A container system for housing a specimen and a substance, comprising:
a container body for receiving the specimen;
a container lid selectively fastenable to the container body, the container lid and the container body forming a sealed enclosure when fastened together;
a compartment extending from an underside of a top wall of the container lid, the compartment retaining the substance when the compartment is sealed;
a compartment film attached to the compartment, the compartment film sealing the substance in the compartment;
a piercing tool comprising an elongated body extending towards the compartment film when the container lid is fastened to the container body, the piercing tool piercing the compartment film and releasing the substance into the container body when a predetermined pressure is applied to the compartment film by the piercing tool.

16. The container system of claim 15,
wherein the container lid and the container body form a liquid-tight system and a gas-tight system when the container lid is fastened on the container body.

17. The container system of claim 15,
wherein the substance comprises a volatile organic compound, the volatile organic compound being formaldehyde.

18. The container system of claim 15, further comprising:
a stop removably fastened to the container body, the stop preventing the container lid from fully fastening on the container body when fastened to the container body,
wherein the stop is a ring fitted around the container body, the ring forming a physical blockage between the container lid and the container body.

19. The container system of claim 15, further comprising:
lid threading attached to the container lid and extending from the underside of the top wall of the container lid; and
body threading attached to the container body,
wherein the lid threading and the body threading are rotationally fastenable such that the sealed enclosure is formed between the container lid and the container body when the body threading and the lid threading are fully rotationally fastened.

20. The container system of claim 19, further comprising:
a stop removably fastened to the container body, the stop preventing the container lid from fully fastening on the container body when fastened to the container body,
wherein the lid threading of the container lid and the body threading are partially rotationally fastened when the stop is fastened to the container body.
